(19) United States
(12) Patent Application Publication
(10) Pub. No.: US 2004/0083269 A1
(43) Pub. Date: Apr. 29, 2004

(54) Method and system for sharing knowledge through adaptive electronic message distribution

(75) Inventor: Fred A. Cummins, Farmington Hills, MI (US)

Correspondence Address: ELECTRONIC DATA SYSTEMS CORPORATION, 5400 LEGACY DR., M/S H3-3A-05, PLANO, TX, 75024, US

(73) Assignee: Electronic Data Systems Corporation

(21) Appl. No.: 10/282,764

(22) Filed: Oct. 29, 2002

(51) Int. Cl. G06F 15/16

(52) U.S. Cl. 709/206; 709/201

(57) ABSTRACT

A system and method for sharing knowledge through adaptive electronic message distribution presents an electronic message topics menu on a web page associated with an electronic message system. The electronic message topic menu permits the user to select topics of interest. Upon the user's selecting the topics of interest from the electronic message topics menu, the system adds the user's electronic message address to electronic message distribution lists associated with the selected topic of interest. The system further monitors user actions relating to electronic message received from the electronic message distribution list to adapt the distribution of electronic message from distribution lists according to user-demonstrated interests. The invention uses a topic hierarchy and system for knowledge-based electronic message communication and management, including distribution list management, thread management, knowledge capture, and participation incentives for enhancing the use of electronic message communications to reach a specialized community of users.

### TECHNICAL FIELD OF INVENTION

The invention, in general, relates to a system and method for sharing knowledge through adaptive electronic message distribution. More specifically, the invention relates to a method using a topic hierarchy and system for knowledge-based electronic message communication and management, including distribution list management, thread management, knowledge capture, and participation incentives for enhancing the use of electronic message communications to reach a specialized community of users. Preferably, the present invention relates to the distribution of electronic mail or e-mail, however, other forms of electronic messages are considered within the scope of the invention.

### BACKGROUND OF THE INVENTION

Electronic message distribution lists are useful for engaging a group of people in the exchange of knowledge and ideas in areas of common interest. In a large organization, many people may have an interest in a particular topic or set of topics. These may be in one or more general topic areas or regarding certain specific targets. If electronic message distribution lists existed for every topic, then an individual could readily engage in sharing knowledge, concerns, and ideas with others having similar interests. However, the creation, management and maintenance of a large number of distribution lists for electronic messages can be a daunting and time consuming task.

Even if it were possible to identify the topics for which the organization should maintain a set of distribution lists, the decisions of who to include and remove from such lists would require a significant human resource commitment. In such practices, an administrator must explicitly add and delete distribution list members, and both the topics and members of the distribution lists should continually evolve. Organizations generally cannot make such commitments. Consequently, developing, managing, and maintaining useful electronic message distribution lists is problematic. Sharing knowledge through electronic messaging, therefore, does not occur effectively in large organizations.

An example of where improved electronic message distribution may be beneficial could be in a large organization where technical specialists may have a problem with a particular vendor product. A technical specialist may, as a result, need to reach a community of people who could share their interest and insights on the vendor product. An electronic message distribution list relating to that product or a similar product may permit the technical specialist to send an electronic message to other specialists on the vendor product distribution list to solicit information without the message also going to a great many others who have no interest or insight into the product problem.

Of course, having such a distribution list or sets of distribution lists would be highly troublesome with known approaches. There are, for example, thousands of software products in use in many large organizations. It would be impractical to centrally create and manage a distribution list for every product. Consequently, there is a need for a method and supporting facilities to reach potential participants and evolve participation in appropriate mailing lists.

Current electronic message distribution lists are simply that. Generally people are placed on a mailing list by request or from some existing list of people that a user wants to reach. Often people ask to be deleted from mailing lists, because they are getting too much input on a topic of no interest to them. Electronic message discussions generally provide information for the moment, but the important contributions are not captured for future reference.

Another problem of existing electronic message distribution systems relates to their inability to organize messages according to general topics and sub-topics within the general topics. Distribution lists in existing systems may be created from hierarchies of subject categories. However, these distribution lists are typically created manually and are relatively static. Moreover, the creation of sub-topics is simply an administrative burden. List membership depends on the administrator knowing who has relevant interest or knowledge (an impossible task), or it relies on individuals taking the initiative to identify and revise their interests and inform the administrator. Also, systems exist that capture electronic message history, but no known system captures selected messages based on merit for compilation in a knowledge catalog for future reference.

In addition, reading electronic messages and participation in such discussions takes the precious time of participants. Clearly, it is more often the case that those who have the most to contribute to an electronic message distribution list have the least amount of time to devote to the endeavor. In order to improve the usefulness of electronic message distribution lists, there is a need to reinforce helpful participation. This may involve both encouraging participation in electronic message distribution lists, as well as encouraging useful contributions of information from electronic message distribution list participants.

Contributed information may be useful not only to a requester, but also to other individuals in other ways. First, if an organization holds the information in a collection of helpful hints relating to the particular discussion topic, others who encounter similar problems in the future may make use of the same contribution without generating more electronic messages. Second, those considering whether to purchase a product or service may review the collection of contributions prior to making the purchase. Third, those individuals who may be in discussions with a vendor may use records of problems to promote resolutions and future product or service enhancements. Also, individuals may add to the collection their feedback from new insights or responses from a product or service vendor to further aid in optimal product understanding and use.

Presently, no known method or system addresses effectively the above needs. There have been, however, numerous less successful attempts. For example, U.S. Pat. No. 6,026,396, entitled “Knowledge-Based Moderator for Electronic message Help Lists,” describes a method of updating a knowledge base containing information about a subject matter. In that patent, the knowledge base is being used to automatically respond to messages containing questions or comments relating to the subject matter. The method of that invention represents and uses stored knowledge to formulate a query for each entry and associate the query with a piece of the stored knowledge so that the piece of stored knowledge is retrieved when a message satisfies the query.

The above solution provides subject matter expert distribution lists, but, as already mentioned, the topics of these lists are too general in scope and can become stagnant. The lists, as a result, do not facilitate communication among focused community of evolving members. Instead, these lists are only useful to aid in distribution of questions or announcements to experts in general subject areas, or contact persons who will further distribute the messages to potentially interested persons. They do not have general use for knowledge sharing beyond this function.

Another approach, known as the eRoom service, provides subjects and conversation threads, in a system permitting messages to be sought out or submitted by persons with access to the topics. The messages are accumulated chronologically within the topic, and any participant may comment on the topic or respond to a specific message. The electronic mail messages generated by this system to alert potential participants, unfortunately, are much delayed and provide insufficient information to generate interest by those who might be interested in participating in the discussion. Moreover, the system of this type provides no category lists to direct messages to specific communities other than all members associated with more general distribution.

Still another approach provides a hierarchy of topics defined by an administrator and allows subject-matter experts to subscribe to topics of interest. Persons may send messages to a list of subject-matter experts under a specific topic. The hierarchy does not contribute to providing a critical mass of participants for sparsely populated topics, and there is no efficient way of adding new members or blocking participation in a specific thread. The knowledge is not catalogued for future reference.

### SUMMARY OF THE INVENTION

In accordance with the present invention, a method and system for sharing knowledge through adaptive electronic message distribution is provided that substantially eliminates or reduces the disadvantages and problems associated with prior electronic message or mail distribution systems and catalogues selected knowledge for future reference.

More specifically, the invention provides a hierarchy-based method and system for requesting and sharing knowledge through adaptive electronic message distribution that presents an electronic message topics menu on a web page associated with an electronic message system. Preferably, the present invention relates to the distribution of electronic mail or e-mail, however, other forms of electronic messages are considered within the scope of the invention. The electronic message topics menu permits the user to select topics of interest. The electronic message topics menu associates with electronic message distribution lists. Upon the user's selecting the topics of interest from the electronic message topics menu, the system adds the user's electronic message address to electronic message distribution lists associated with the selected topics of interest. The system monitors user actions relating to electronic message received from the electronic message distribution list for adapting the distribution lists in response to user-demonstrated interests.

A technical advantage of the present invention is the ability to create generalized or specialized communities of interest. Participation in general and specialized categories automatically adapts distribution list membership. With the present invention, new topics, i.e., specializations, initially inherit members from associated general topics. This helps the initial population and evolution of distribution list members for the new topics.

Another technical advantage of the present invention is that members can be added to a distribution list by being added to a thread response. As a result, a community of interest grows when initial participants identify persons with potential interest in the topic(s) by adding their email addresses to a response.

Yet another technical advantage of the present invention is that a person easily can drop out of a thread without being dropped from a distribution list. Threads are identified by a unique electronic message address instead of a subject line. Consequently, threads are tightly controlled with thread-specific participants. With the present invention, a subject line may be used to more clearly describe the content of the message.

A further technical advantage of the present invention is the ability for members of a community of interest to easily endorse and, in one embodiment, rate important contributions to an area of interest. This may permit the electronic mail messages to be filtered and organized for valuable future reference.

Yet another technical advantage of the present invention is the generation of soft incentives for greater user contribution and participation. With the present invention, their peers recognize contributors by endorsing their contributions. Data from these endorsements may also create the basis for additional incentives such as awards and bonuses. The present invention, therefore, encourages the most engaged, successful leaders to direct and mentor others through contributing their knowledge for potential recognition as rated, endorsed electronic mail.

In summary, the present invention promotes participation, enables easy refinements or changes in distribution list participation, allows opting in or out of specific threads while preserving participation in a general or specific topic, and captures important knowledge for future reference. These aspects of the present invention work together to achieve the overall goal of knowledge sharing through adaptive electronic message distribution.

Other technical advantages are readily apparent to one skilled in the art from the following figures, description, and claims.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 illustrates a general purpose computer that may be used in a distributed electronic message system created in accordance with the invention;

FIG. 2 conceptually shows a hierarchical distribution list management process for sharing knowledge through adaptive electronic mail distribution lists formed and operating according to the teachings of the present invention;

FIG. 2A depicts a typical user interface for use with the present embodiment of the invention; and

FIG. 3 conceptually further demonstrates a thread management process for sharing knowledge through adaptive electronic message distribution consistent with the teachings of the present invention.

### DETAILED DESCRIPTION OF PREFERRED EMBODIMENT

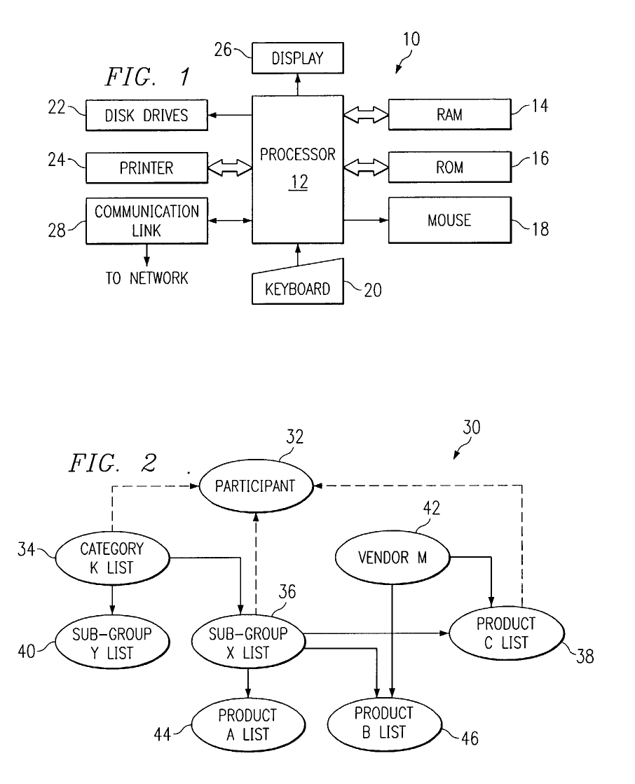

The preferred embodiment of the present invention and its advantages are best understood by referring to FIGS. 1-3 of the drawings, like numerals being used for like and corresponding parts of the various drawings.

Many users have a tremendous amount of business and technical knowledge. Unfortunately, a large organization often does not know what the sum of the individuals in the large organization knows or who in the organization has knowledge pertinent to a particular problem. When a problem arises, it is difficult to find relevant knowledge, most of which exists in the heads of the employees and consultants for the large organization. The system of the present invention addresses this problem by providing the potential to dynamically create and evolve communities of interest that can share knowledge around the globe. Preferably, the present invention performs dynamic creation and evolution of interest communities through the dynamic generation of electronic mail distribution lists.

In addition, with the present invention, selected knowledge is captured and cataloged for future reference. This may significantly improve the ability of a large organization to use existing knowledge and achieve synergies among members of communities of interest engaged in the development of new ideas, products, and services.

FIG. 1 illustrates a general-purpose computer 10 that may be used in an adaptive electronic message distribution system created in accordance with the invention. The general-purpose computer 10 along with similar computers may be used to execute distributed applications and/or distributed system services in accordance with the invention, particularly in the creation and communication of electronic mail messages. General-purpose computer 10 may also be used in electronic communications systems other than present electronic message distribution system, however, it here provides an understanding of how one might interface and use the system of the present invention. General-purpose computer 10 may be adapted to execute any of the well-known OS2, UNIX, MAC-OS, and WINDOWS operating systems or other operating systems. General-purpose computer 10 comprises processor 12, random access memory (RAM) 14, read-only memory (ROM) 16, mouse 18, keyboard 20, and input/output devices such as media drives 22, printer 24, display 26, and communications link 28. The present invention includes programs that may be stored in RAM 14, ROM 16, or media drives 22 and may be executed by processor 12. Communications link 28 connects to a computer network but may be connected to a telephone line, an antenna, a gateway or any other type of communications link. Media drives 22 may include a variety of types of storage media, such as, for example, floppy disk drives, hard disk drives, CD ROM drives or magnetic tape drives.

Although the embodiment of FIG. 1 employs a plurality of media drives 22, a single disk drive 22 may be used without departing from the scope of the invention. FIG. 1, therefore, only provides one example of a computer that may be used with the invention. The invention may be used in computers other than general-purpose computers, as well as on general-purpose computers without conventional operating systems.

In addition, although FIG. 1 shows a single computer, the preferred embodiment of the present invention contemplates a network of potentially many such computers. This is especially important in view of the fact that electronic messaging contemplates generally many computers networked together and through which many individuals are communicating with one another. Accordingly, the present invention should be viewed as operating in an environment of a highly variable number of general-purpose computers 10, both within an organization, as well a between groups of individuals amongst a potentially large number of different organizations or facilities.

General-purpose computers such as general-purpose computer 10 of FIG. 1, or specialized computers may be used to execute electronic mail systems. These systems accept messages and deliver them to computer mailboxes of recipients according to the addresses in the message. Recipients can read the messages when they have the time to do so, in any order. Messages may be directed to a distribution list to be forwarded to the members of the distribution list so that a sender need not know or be concerned with maintaining the membership of a distribution list (AKA mailing list), being only concerned that the message be delivered to persons identified as appropriate to the subject matter associated with the distribution list. Electronic mail may be communicated using a standard protocol such as SMTP (Simple Mail Transport Protocol) or by other means by which messages are accepted, delivered and held for recipients. Preferably, the present invention relates to the distribution of electronic mail or e-mail, however, other forms of electronic messages are considered within the scope of the invention.

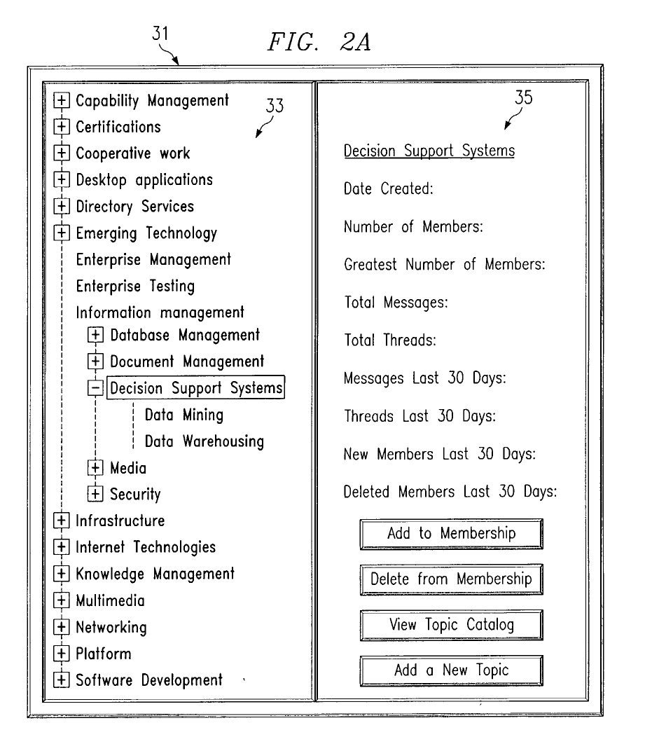

In the electronic message management system of the present invention, the topics of mailing lists may be organized in a hierarchy, as FIG. 2 depicts, so that specific topics are grouped into general categories and specific or sub-categories. FIG. 2, therefore, conceptually depicts distribution list management process 30 of the present invention whereby participant 32, may become a member of Category K List, which may be a general topic list 34, while Sub-Group X List may be a sub-topic list 36, and Product C List, as a specific product listing 38. Sub-topic list 40, here Sub-Group Y List, may relate to general topic list 34.

A principal purpose of the hierarchy in process 30 is for members of sub-groups to be implicitly included as members of a more general group, and for small groups to be extended by automatic inclusion of members of a more general group. This may be due to the smaller groups being more likely to have an interest in particular topics than will the general population. Also specific product lists 44 and 46, here Product A List and Product B List, may relate to specific topic list 36, as well as may Product C list 38.

Distribution list management hierarchy 30 supports the evolution of participant groups from general topics to more specific topics, and vice-versa, as specialized specific topics emerge and grow. The hierarchical structure of distribution list management process 30 also addresses increases and decreases over time in participation. Participant 32 may initially subscribe to a general category reflecting an area of interest, such as to general topic lists. As sub-topics and associated participant sub-groups are defined, such as through specific topic list 36, participant 32 may desire only to be in the sub-group and, therefore, may block electronic messages from the general topic list 34. Participant 32 also may desire to subscribe to more specific sub-categories. Where there may be an interest in one or more specific topics, participant 32 may create a new electronic message distribution list for the specific topic(s).

In the preferred embodiment, topics may be made available to participants and potential participants on a web page or similar interface whereby the user may see the different general and specific topics relating to different electronic message distribution lists. FIG. 2A, therefore, provides an example of such an interface 31. Clearly, however, a wide variety of different interfaces may be used for purposes of the present invention. Thus, in FIG. 2A, the categories and specific topics may appear in a hierarchical list with associated check boxes 33, hyperlinks, or other means for designating the associated distribution lists for indicating the distribution topics for which the user desires to be a participant. The user may indicate change in subscriptions by changing the check marks within the check boxes, for example. The topics display may also show, as in list 35, the current number of subscribers for each topic both at the general and the specific topic level(s), as well as other information relating to decision support systems.

Note that preferably specific topics, such as Sub-Group X List or Sub-Group Y List, may be assigned to more than one category. Information presented to the user regarding different topics may also include attributes such as a product vendor, and even information relating to a product or service vendor, for example. This may allow placing specific topics under multiple classifications, as well as allowing general topics to reflect a bundling of characteristics that may further be included under all relevant categories.

When a participant creates a new sub-group or specific topic, the new sub-group may only include, as an initial list member, the participant who created the sub-group. However, when distributing a message for that topic, the knowledge sharing system of the present invention may include participants from the more general category in order to distribute the message to a sufficient number of participants having similar interests. When recipients of the message respond, the system of the present invention may add each respondent to the new, more specific topic list. Also, the system permits subscribing explicitly to a specific distribution list if the prospective participant has an interest in the topic without the individual having to respond to the messages.

A participant seeking to make a request for information may call up a mailing list browser display showing the available topics. If an appropriate topic exists, the participant may select the topic. In response to the selection, the participant may receive a form that he may complete to enter a request. Note here that although the present embodiment uses an electronic mail message, this and other steps of the present process could be similarly or equivalently performed using a browser form. Alternatively, the participant could direct a request message to the topic (i.e., the distribution list) with the same effect. Other forms of communication such as these described are well within the scope of the present invention.

Upon the participant sending the form containing the request to the system of the present invention, the system adds the participant automatically to the associated electronic message distribution list. Again, such a distribution list preferably relates to electronic message distribution. However, other forms of message distribution may occur, most likely producing less attractive results, but with different aspects that may make them desirable. If the topic list menu fails to include an appropriate topic relating to the participant's desire, the participant may request the creation of a new topic. Such a new topic may be a specialization of an existing category or a generalization of multiple topics. If the new topic is a specific topic, the user may identify the topic type. The topic type may determine the attributes that the system of the present invention may provide for cross-referencing the topic. For example, a software product may require specification of a vendor and a platform on which the software operates; the system may use these attributes for cross-referencing the topic.

When a participant receives an information message or a request for information message from the message distribution system, s/he may have several options. First, the participant may ignore the message and continue to receive messages from the same thread and the same distribution list. Secondly, the participant may send a response to the request. Such a response may provide insight on the issue that the participant possesses. Thirdly, the participant may block the topic from the web page list and possibly subscribe to others. Finally, the participant may simply withdraw from the thread, remaining on the distribution list for future messages on new threads.

The first two of these actions may be considered as normal electronic message options. The third of the above options occurs by the user selecting an appropriate URL from the message footer that each message includes. The URL may bring up a browser page allowing the user to change distribution list selections. The thread management process discussion below describes the thread withdrawal option.

A participant may vary the number of and specific ones of the subscriptions to which he is a member over time. Initially, for example, a participant may subscribe to a general category, such as the Category K List 34. As the participant develops more refined interests and as the hierarchical list of topics grows, the participant may subscribe to more specific categories, such as to Sub-Group X List 36 or Products C List 38.

The knowledge sharing system of the present invention monitors the activity levels on the various topics. When activity on a particular topic ceases for an extended period, that topic is a candidate for deletion. If a specific topic is deleted (automatically or at administrator discretion), the subscribers to distribution lists associated with the topic may be reassigned to the more general topic relating to the deleted topic.

Over time, the topics may proliferate, or topic descriptions may become inappropriate. In either instance, an electronic message distribution list administrator may change the structure of the hierarchy or the topic descriptions with the understanding that the topics may relate to subscribers, as well as active message threads. Subscribers and active threads may remain with a category regardless of the name or structure change.

The system of the present invention assigns electronic mail distribution list addresses to messages being distributed. Accordingly, the visible from/to caption associated with the electronic mail distribution list may hold the current topic name. The electronic mail recipient, consequently, may see the topic name as the electronic mail sender. The actual email address is specific to the thread, as will be discussed, below.

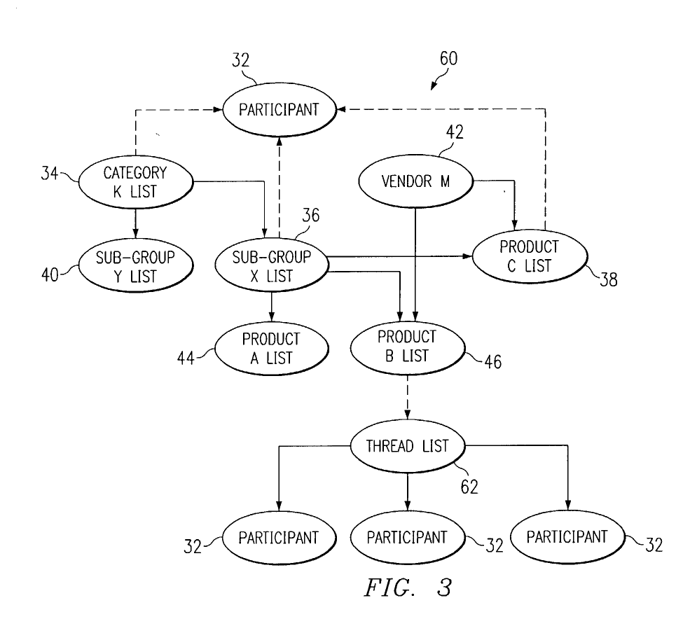

FIG. 3 demonstrates conceptually thread management process 60, which may associate with list management process 30 of FIG. 2. For example, thread management process 60 may associate, for example, with a thread of electronic mail, Thread List 62 relating to a specific Product B list 46. Thus, when a participant begins a request or a new discussion, the initial message and responses to the message form a discussion “thread.” In the system of the present invention, the discussion thread receives a unique electronic mail address. The unique electronic mail address identifies both the associated topic(s) and the thread itself. The present knowledge sharing system treats the thread as a specialization of the associated topic to which the thread relates. Thread participants may come from the distribution list members for the associated topic as well as from distribution list associated with more general categories. This would occur if the number of participants did not meet a defined threshold.

If additional electronic mail addressees are added to a response, these electronic mail addresses may be added to the list of thread participants and stripped from the addressee list in the message when the system forwards the response to other members of the thread distribution list. These additional participants also may be added to the members of the electronic mail distribution list for the associated topic. This will aid in developing the number of participants for the topic distribution list.

Each participant has the option of withdrawing from a particular thread by selecting a URL from the message footer that the knowledge sharing system of the present invention provides. The URL may invoke appropriate functionality through the user's web browser accordingly to update the knowledge sharing system. Parameters in the URL also may identify the specific thread and the particular participant. The web-based application may also provide a simple response to acknowledge the request without posing a significant communication delay (e.g., an independent, pop-up window that does not replace any existing browser display). Alternatively, the participant may withdraw by sending a response with an appropriate key word in the subject line or text. The withdrawal preferably will only affect participation in the particular thread and not the distribution list generally.

The thread management process of the present invention also permits a participant to add names to a thread. This may be accomplished by sending a response with additional addressees. At the same time, a participant may terminate his or her individual thread participation. This essentially accomplishes a forwarding of the request to others who may be better able to contribute.

In facilitating the recognition, classification and future retrieval of valuable threads, responders to a request may modify the message subject line to describe their response content more appropriately. For example, the participant may use the subject line as a short description of the response for future reference.

The present invention also provides a knowledge capture function. The knowledge capture function particularly deals with responses to questions that represent knowledge that may be of value in the future. The knowledge sharing system of the present invention selectively captures and catalogs the responses for future reference. All requests and responses may be captured by the knowledge capture function in a historical record as they are forwarded to distribution list participants. The present invention makes it possible to access a web page to obtain a particular thread. Information relating to the thread would include senders and subject lines of each response for quick reference.

A particularly important aspect of the present invention includes the ability to selectively file responses as a function of the technical merit or other value the electronic message possesses. To accomplish the selective filing, any recipient (except the sender, preferably) may endorse a response to be cataloged for future reference. Endorsed responses are cataloged as knowledge under the associated topic. If a recipient believes a response should be cataloged, the recipient may select a designated URL in the message footer and submit a request through the system browser in the form of parameters in an HTTP request (or other appropriate protocol). Preferably, the originator of a response may not endorse his or her response, but others may do so. The system may provide multiple URLs to enable scoring of the response in different ways. The endorser thereby can place an appropriate value on the response. Alternatively, the URL could return a display in which a rating could be selected and submitted.

Endorsed responses for each topic preferably are indexed by subject line and date in the present system. Also, endorsements are accessible by reference to the various threads on that topic. Multiple recipients may endorse a response for cataloging. The catalog may show a record of each of the recipients who submitted an endorsement.

Also, at a later time, when the system web page permits retrieval of an endorsed response, a user may endorse the response at that time if the response has been found useful. Consequently, recognition of some responses may grow over time.

The present invention may use electronic mail to deliver retrieved endorsed responses. A user may, for example, select an endorsed response from an associated topic list. When the user selects the item, the system may deliver the response as an electronic message just as the original response was delivered. However, this delivery will be only to the specific user and not to the entire associated distribution list. The user may then revive the thread by responding to the message, or endorse the response if the user finds the response to be useful. By using electronic message, the user has a message for each solution he has requested. This permits the user to file the particular messages in personal folders for future reference or endorsement.

Another aspect of the present invention addresses the fact that electronic mail users often receive excessive quantities of electronic mail. Because sifting through many electronic messages for useful information consumes time, and when the recipient must review a large number of messages, important messages may be overlooked. Consequently, many users are reluctant to subscribe to electronic message lists they may view as only increasing further their electronic message volume.

The knowledge sharing system, therefore, further provides a set of functions giving users incentives for participation in electronic message distribution lists. By tracking and reporting the activity associated with the electronic message distribution list, the present invention makes user participation known within the organization. The reporting may provide measures of participation that may be visible to the rest of the organization, as well as personal records for the individual to monitor his or her personal activities and reports for managers. The reporting to managers and the organization as a whole should be designed to be appropriate for positive reinforcement, for the organization culture and for compliance with local confidentiality laws and regulations.

In one embodiment of this aspect, a record for each thread may capture information on (1) the person who initiated the thread, (2) the persons who responded to the thread and the number of times they responded, (3) the persons whose responses were endorsed for future reference and the associated scores, and (4) the persons who made endorsements and the score they assigned.

The present invention may also record activity against the captured knowledge. The present system also may provide a web-accessible record for each endorsed response, including the person who submitted the response; the number of requests for the recorded knowledge, the persons who endorsed the response, and the scores they assigned to the response.

The present invention also provides each participant with Internet access to a summary of his or her activity. In one embodiment, the summary includes (1) the number of threads initiated, (2) the number of responses written by the participant, (3) the responses endorsed together with the received scores, and (4) the endorsements made by the participant and scores the participant assigned. The present invention also may recognize referrals by tracking the number of persons who were added to threads and, further, the number who did not immediately drop from the threads. This would, of course, reveal those persons who were brought into a thread that continued to participate for a meaningful period of time.

Finally, a summary web page to highlight the overall system activity, as well as to identify individuals contributing high levels of endorsed responses. Moreover, the activity tracking functions here described will permit additional management reports to be defined in support of administration of other incentives.

Accordingly, it is to be understood that the embodiments of the invention herein described are merely illustrative of the application of the principles of the invention. For example, as an alternative to electronic mail distribution, using different forms of distribution, such as chat, real-time messaging, bulletin board messaging, or other embodiments to achieve the purpose of sharing knowledge through adaptive electronic message distribution are considered to be within the scope of the present invention. Reference, therefore, herein to details of the illustrated embodiments are not intended to limit the scope of the claims, which themselves recite those features regarded as essential to the invention.

We claim:

1. A method for adaptively managing electronic message distribution lists, comprising the steps of:
organizing a plurality of electronic message distribution lists in an hierarchical association, wherein said hierarchical association comprises at least one major category electronic message distribution list including electronic message addresses relating to a general interest area;
associating at least one sub-category under said at least one major category for including electronic message addresses of a specific interest area under said general interest area,
distributing a message directed to a general category according to the electronic message addresses of the category and its sub-categories.

2. The method of claim 1, further comprising the steps of distributing a message directed to a sub-category to the electronic message addresses of the sub-category and including the electronic message addresses of its general category if the number of electronic message addresses of the sub-category fails to meet a defined threshold.

3. The method of claim 1, further comprising the step of allowing an electronic message addressee on said sub-category electronic message to controllably block electronic messages sent to electronic message addressees on said major category distribution list.

4. The method of claim 1, wherein a single one of said at least one sub-category electronic message distribution list may hierarchically associate with a plurality of more general category electronic message distribution lists so that its members will be included in the distribution of messages directed to any one of its associated more general category electronic message distribution lists.

5. The method of claim 1, wherein upon receiving a message directed to a particular category electronic message distribution list, performing the step of adding to the category electronic message distribution list the originator of said electronic message.

6. The method of claim 5, further comprising the step of explicitly subscribing electronic message addressees to the associated category electronic message distribution list when said addressees have been specified in a response message distributed for the said category electronic message distribution list.

7. The method of claim 1, wherein a sub-category may be in a plurality of general categories.

8. The method of claim 1, wherein upon deleting a category, participants are added to a related more general category.

9. The method of claim 1, wherein a category comprises a plurality of attributes for grouping said category into at least one classification based on said plurality of attribute and values of said plurality of attributes.

10. The method of claim 1, wherein further comprising the step of adding to a specific category upon the participant being taken from a related category by virtue of the specific category having an insufficient number of members.

11. The method of claim 1, further comprising the step of adding a participant to associated category upon said participant being added as an participant of a response.

12. A method for managing a thread of electronic messages, said thread comprised of a message directed to a category electronic message distribution list and responses to said message subsequently directed to said category electronic message distribution list as well as responses to responses directed to said category electronic message distribution list, said thread managing steps comprising the steps of:
assigning a unique electronic message address to a thread of electronic messages, said unique electronic message address further identifying the category associated with said thread of electronic messages and said thread of electronic messages; and
forming a thread electronic message distribution list for said thread of electronic messages.

13. The method of claim 12, wherein said thread electronic message distribution list initially derives from the associated category electronic message distribution list that was the target of the initial electronic message of the thread.

14. The method of claim 12, further comprising the step of adding at least one electronic message addressee of a thread response to the associated category electronic message distribution list for increasing the size of said category electronic message distribution list.

15. The method of claim 14, further comprising the step of identifying a specific thread associated with said thread message and the withdrawing addressee only from the electronic message distribution list of the thread.

16. The method of claim 12, wherein a category name may be changed without affecting the participants or the associated threads.

17. The method of claim 12, wherein relationships between categories may be changed without affecting the participants or associated threads.

18. The method of claim 12, wherein a participant may initiate a thread by selecting a category from the browser showing available categories, and obtaining a message entry display for the message.

19. The method of claim 12, wherein upon a participant sending a message to a category, said participant is automatically added to the category.

20. The method of claim 12, wherein a thread is assigned a unique electronic message list address associated with the participants assigned to the specific thread.

21. The method of claim 12, wherein a thread electronic message address may include a descriptive thread name based on the category.

22. The method of claim 12, further comprising the step of adding a participant to thread who is added as an participant of a response.

23. The method of claim 12, further comprising the step of wherein, on request, removing a participant from a thread without removing them from the category.

24. The method of claim 12, further comprising the step of withdrawing a participant from a thread by providing a URL in the message footer where said URL comprises parameters for specifying the thread, the participant, and the category.

25. The method of claim 12, wherein a subject line of a thread message may be changed by a participant to be descriptive of the response without disassociating the message from the thread.

26. The method of claim 12, wherein a historical record of each thread may be accessible through a display showing the subject lines and dates of each message.

27. A method for selectively capturing and cataloging electronic messages, comprising the steps of:
capturing electronic messages in a historical record of captured electronic messages;
organizing a plurality of captured electronic messages in an hierarchical association, wherein said hierarchical association comprises at least one major category of captured electronic message including captured electronic messages relating to a general interest area;
associating at least one sub-category under said at least one major category for including captured electronic messages of a specific interest area under said general interest area;
capturing an electronic message when it is endorsed by a recipient who perceives a continuing value of said captured electronic message.

28. The method of claim 27, wherein a participant may endorse a message to be catalogued for future reference, and may rate the value of the message.

29. The method of claim 27, wherein an endorsed message is cataloged under the associated category, showing endorsement(s) and indexed by the subject line and date.

30. The method of claim 27, wherein multiple participants may endorse a message and the catalog entries will show the multiple endorsements.

31. The method of claim 27, further comprising the step of providing a URL in the message footer where the URL may have parameters to specify the thread, the participant, the message and a level of endorsement.

32. The method of claim 27, further comprising the step of providing a URL in the message footer where the the URL may bring up a display for specifying level of endorsement.

33. The method of claim 27, wherein a message selected from the catalog is mailed specifically to the participant selecting it so the participant may file it or forward the message.

34. The method of claim 27, wherein a message may be retrieved from the catalog at a future time and endorsed.

35. The method of claim 27, wherein a thread may be resumed by retrieving a message from the catalog and sending a response.

36. A method for encouraging participation in electronic message communication within an organization, comprising the steps of:
tracking participation in threads of electronic messages associated with electronic message distribution lists relating to predetermined topics of interest;
generating a plurality of reports deriving from said tracking participation; and
communicating to pre-selected recipients within the organization said plurality of reports.

37. The method of claim 36, wherein said plurality of reports provide information on participants initiating threads.

38. The method of claim 36, wherein said plurality of reports provide information on participants contributing to threads

39. The method of claim 36, wherein said plurality of reports provide information on participants making endorsements.

40. The method of claim 36, wherein said plurality of reports provide information on participants receiving endorsements.

41. The method of claim 36, wherein said plurality of reports provide information on endorsed messages frequently referenced.

42. The method of claim 36, wherein said plurality of reports provide information on messages with high numbers of endorsements or high ratings.

43. The method of claim 36, wherein at least one web page associated with said method provides general access to information regarding participants receiving high numbers of endorsements.

44. The method of claim 36, wherein participants will not be allowed to endorse their own responses.

45. The method of claim 36, wherein a web page for each participant may provide information on the level of participation.
